(19) United States
(12) Patent Application Publication
(10) Pub. No.: US 2026/0205917 A1
(43) Pub. Date: Jul. 16, 2026

(54) COMMUNICATION SCHEME CAPABLE OF SIMULTANEOUSLY SENDING/RECEIVING AUDIO DATA AND NON-AUDIO DATA TO/FROM DIFFERENT PERIPHERAL DEVICES BASED ON DIFFERENT CHANNELS

(71) Applicant: PixArt Imaging Inc., Hsin-Chu City (TW)

(72) Inventor: Jr-Kai Liang, Hsin-Chu City (TW)

(73) Assignee: PixArt Imaging Inc., Hsin-Chu City (TW)

(21) Appl. No.: 19/019,521

(22) Filed: Jan. 14, 2025

(51) Int. Cl. H04W 40/02; G06F 3/16; H04W 40/24

(52) U.S. Cl. CPC H04W 40/02; G06F 3/162; H04W 40/24

(57) ABSTRACT

A communication method of a Bluetooth communication device which is coupled to an radio and antennal control circuit includes: providing a host microcontroller to send audio data and non-audio data to a host controller interface; using a first Bluetooth controller dedicated to receive the audio data from the host controller interface and to control the antenna control circuit to use a first pathway of the radio circuit to send the audio data; and, using a second Bluetooth controller to receive the non-audio data from the host controller interface and to control the antenna control circuit to use a second pathway of the radio circuit to send the non-audio data. Bluetooth controllers are separated to get more timings and frequency usage efficiency.

### BACKGROUND OF THE INVENTION

### 1. Field of the Invention

The invention relates to a Bluetooth communication device, and more particularly to a Bluetooth communication device and a corresponding Bluetooth communication method.

### 2. Description of the Prior Art

Generally speaking, for a conventional Bluetooth communication scheme, the audio data requires to have a low latency and avoids non-real-time transmission. The audio packet being composed of the audio data may occupy a relatively long time slot compared to that occupied by a data packet formed by the non-audio data, and the transmission of an audio packet will be given a priority higher than that of the transmission of a data packet when it is needed to compete the resources. This inevitably causes a user to experience occasional freezes when the user is using/operating a mouse device and a keyboard device while is also playing music and answering calls.

### SUMMARY OF THE INVENTION

Therefore one of the objectives of the invention is to provide a Bluetooth communication device and a corresponding communication method, to solve the above-mentioned problems.

According to embodiments of the invention, a Bluetooth communication device is disclosed. The Bluetooth communication device, coupled to a radio circuit and an antenna control circuit, comprises a host microcontroller, a first Bluetooth controller, and a second Bluetooth controller. The host microcontroller is used for sending audio data and non-audio data to a host controller interface. The first Bluetooth controller, coupled between the host microcontroller and the antenna control circuit, is dedicated for receiving the audio data from the host controller interface and for controlling the antenna control circuit to use a first pathway of the radio circuit to send the audio data. The second Bluetooth controller, coupled between the host microcontroller and the antenna control circuit, is used for receiving the non-audio data from the host controller interface and for controlling the antenna control circuit to use a second pathway of the radio circuit to send the non-audio data.

According to embodiments of the invention, a communication method of a Bluetooth communication device which is coupled to a radio circuit and an antenna control circuit is disclosed. The communication method comprises: providing a host microcontroller to send audio data and non-audio data to a host controller interface; using a first Bluetooth controller dedicated to receive the audio data from the host controller interface and to control the antenna control circuit to use a first pathway of the radio circuit to send the audio data; and, using a second Bluetooth controller to receive the non-audio data from the host controller interface and to control the antenna control circuit to use a second pathway of the radio circuit to send the non-audio data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an example application of the Bluetooth communication device as shown in FIG. 2 according to an embodiment of the invention.

FIG. 2 is a block diagram of the Bluetooth communication device according to an embodiment of the invention.

FIG. 3 is a block diagram of the Bluetooth communication device according to another embodiment of the invention.

FIG. 4 is a block diagram of the Bluetooth communication devices according to another embodiment of the invention.

FIG. 5 is a diagram showing the comparison between the conventional scheme's example and the example of the invention of data transmission of different Bluetooth peripheral devices as shown in FIG. 1 according to an embodiment of the invention.

FIG. 6 is a diagram of the Bluetooth controllers respectively sending audio data and non-audio data based on different time lengths of the different time periods according to an embodiment of the invention.

### DETAILED DESCRIPTION

The invention aims at providing a technical solution capable of and dedicated for individually transmitting/transporting the different kinds of data having different latency requirements through the different Bluetooth connections of an radio circuit at the same time, to integrate the transmissions of Bluetooth data having the different latency requirements into a single communication system, e.g. the integration of transmissions of both audio data and non-audio data.

Actually, for Bluetooth communication, the audio data may require to have a low latency and avoid non-real-time transmission. The audio packet being composed of the audio data may occupy a relatively long time slot compared to that occupied by a data packet formed by the non-audio data, and the transmission of an audio packet will be given a priority higher than that of the transmission of a data packet when it is needed to compete the resources. This inevitably causes a user to experience occasional freezes when the user is using/operating a mouse device and a keyboard device while is also playing music and answering calls.

In the embodiments, the Bluetooth controllers dedicated for respectively transmitting the audio data and non-audio data can be integrated into a single one integrated circuit (IC) chip or can be integrated into a single system-in-package based on System in Package (SiP) technology (but not limited) which can be used for integrating multiple integrated circuits (ICs), to use different Bluetooth RF channels with the same radio circuit, so that the different kinds of data having different latency requirements can be transmitted simultaneously. This greatly improves the performance and reduces the circuit costs.

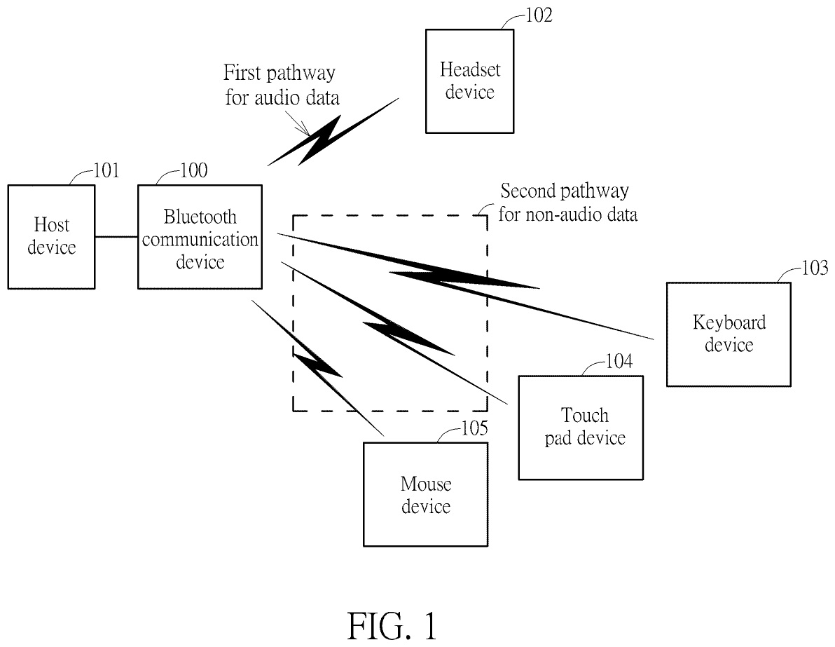

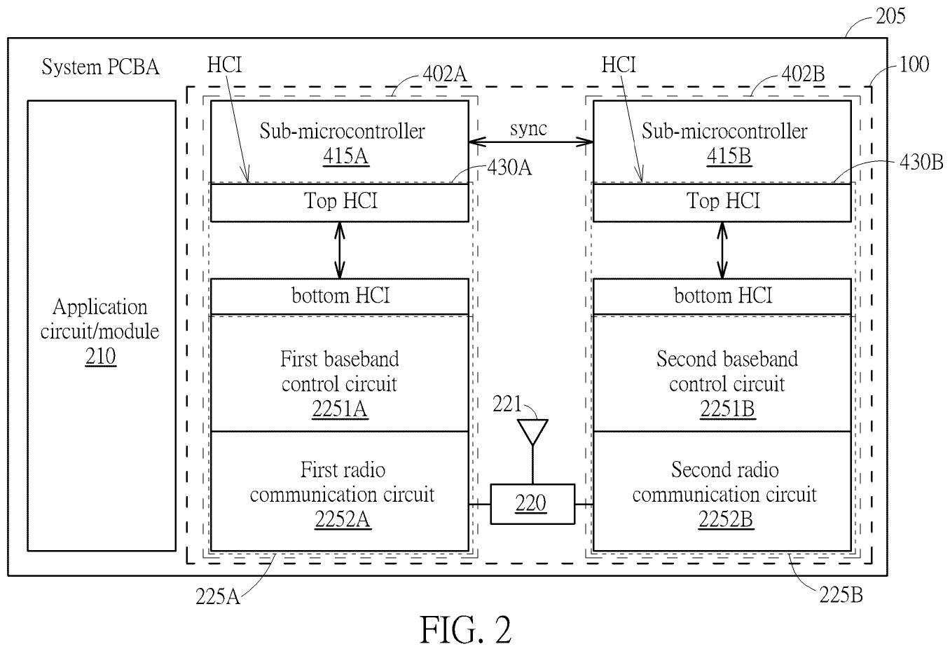

Refer to FIG. 1 in conjunction with FIG. 2. FIG. 1 is a diagram of an example application of the Bluetooth communication device 100 as shown in FIG. 2 according to an embodiment of the invention. FIG. 2 is a block diagram of the Bluetooth communication device 100 according to an embodiment of the invention.

As shown in FIG. 1, the Bluetooth communication device 100 for example is coupled to the host device 101 such as a personal computer (PC) device, mobile phone, tablet or other devices which need multi-data/audio Bluetooth connections. The Bluetooth communication device 100 has multiple Bluetooth connections respectively used to (or dedicated to) wirelessly send different kinds of Bluetooth peripheral data to the different Bluetooth peripheral devices such as an audio play device (e.g. a headset device) and a human interface device (e.g. keyboard device, optical mouse device, touch pad device, etc.). For instance, the Bluetooth communication device 100 can send the audio data (e.g. audio data stream) to the headset device 102 through the first Bluetooth connection and simultaneously send/receive the non-audio data to/from at least one of the keyboard device 103, touch pad device 104, and mouse device 105 with other Bluetooth connections. One Bluetooth connection means data communication between device 100 and the other device (as 102, 103 . . . , 105 etc.). The audio data and non-audio data are generated by the host device 101 into the Bluetooth communication device 100. The audio data, transmitted through the first connection, is music data which is used to control the headset device 102 to play music for a user based on the audio data or is the user's voice data sensed and generated by the microphone of the headset device 102 to transmit the voice data to the host device 101 through the first Bluetooth connection and Bluetooth communication device 100. The non-audio data, transmitted through the second Bluetooth connection is used to make the Bluetooth communication device 100 negotiate with the at least one human interface device such as the keyboard device 103, touch pad device 104, and mouse device 105 bi-directionally so that the user can interact with the software programs running on the host device 101 through operating and controlling the at least one human interface device.

As shown in FIG. 2, in one embodiment, in order to easily implement the circuits, a host microcontroller may be divided into two sub-microcontrollers which may be respectively integrated with the first and second Bluetooth controllers and disposed at different Bluetooth communication circuits. For example, in practice, the Bluetooth communication device 100 is installed on the system PCBA 205 and coupled to the application circuit/module 210 of the host device 101, and the application circuit/module 210 is also installed on the system PCBA 205. The Bluetooth communication device 100 may be a device module comprising two or more than two Bluetooth communication circuits and for example the device module is implemented by using a single package based on System in Package (SiP) technology (but not limited).

For example, a first Bluetooth communication circuit 402A, dedicated for processing and transferring the audio data, comprises a first sub-microcontroller 415A and a first Bluetooth controller 225A which is coupled to the first sub-microcontroller 415A through a first HCI 430A having a top HCI and a bottom HCI, and a second Bluetooth communication circuit 402B, used for processing and transferring the other kinds of data such as the non-audio data different from the audio data, comprises a second sub-microcontroller 415B and a second Bluetooth controller 225B which is coupled to the second sub-microcontroller 415B through a second HCI 430B having another top HCI and another bottom HCI. Further, for advance integrated, in one embodiment, the first and second sub-microcontrollers 415A and 415B can be integrated to one microcontroller to reduce current consumption, circuit size and cost.

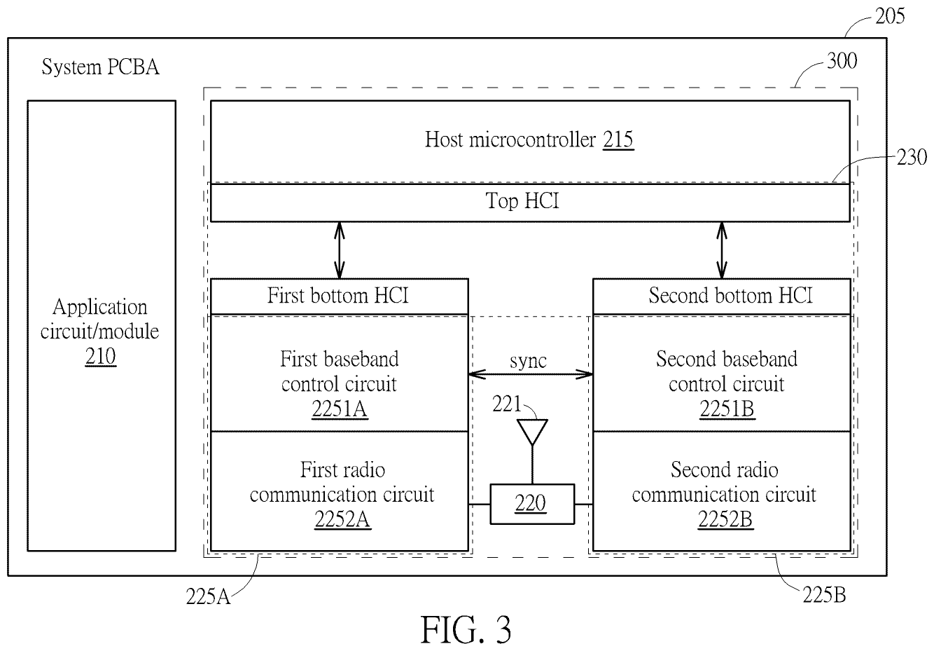

The sub-microcontroller 415A is used to send the audio data to the host controller interface 430A which uses its top HCI to transfer the audio data to its bottom HCI that can transfer the audio data to the first Bluetooth controller 225A which is dedicated to process and transfer only the audio data, and at the same time the sub-microcontroller 415B is used to send the non-audio data to the host controller interface 430B which uses its top HCI to transfer the non-audio data to its bottom HCI that can transfer the non-audio data to the second Bluetooth controller 225B which is used to process and transfer the non-audio data different from the audio data. Similarly, the functions and operations of first Bluetooth controller 225A and second Bluetooth controller 225B in FIG. 2 are identical those mentioned in the embodiment of FIG. 3, and are used respectively individually send the audio data and the non-audio data to the different Bluetooth peripheral devices through different Bluetooth channels of the radio circuit 221 during the same time period.

Further, FIG. 3 is a block diagram of the Bluetooth communication device 300 which has the same functions and operations of device 100 as shown in FIG. 1 according to another embodiment of the invention. In practice, as shown in FIG. 3, the Bluetooth communication device 300 is for example installed on a system printed circuit board assembly (PCBA) (or a system printed circuit board (PCB)) 205 and coupled to the application circuit/module 210 of the host device 101 on the system PCBA 205; the application circuit/module 210 is also installed on the system PCBA 205 and may transmit/receive data to/from the Bluetooth communication device 300. In addition, the Bluetooth communication device 300 is also externally coupled to the antenna control circuit 220 which is connected to the radio circuit 221 such as an antenna portion (e.g. physical antenna coil(s)), and the antenna control circuit 220 can control the radio circuit 221 can adjust the arrangement of the physical antenna coils in the radio circuit 221 by controlling electronic switches or other electronic components within the radio circuit 221 and it may include RF (radio-frequency) switch or RF filter for RF signal switching to desired path. In traditional technology, if two communication technologies share the same antenna coils, the antenna control circuit needs to adjust the radio circuit's different configurations for different communication technologies through time division. In contrast, the invention can use the same coil configuration, and this means that the antenna control circuit in the invention does not need to switch the radio circuit. The two communication interfaces can communicate simultaneously in the same period and work simultaneously through frequency divisions.

The Bluetooth communication device 300 comprises a host microcontroller 215, a first Bluetooth controller 225A, and a second Bluetooth controller 225B. The first Bluetooth controller 225A, coupled between the host microcontroller 215 and the antenna control circuit 220, is dedicated for receiving the audio data from the host controller interface and for controlling the antenna control circuit 220 to use a first pathway of the radio circuit 221 to send the audio data. The second Bluetooth controller 225B, coupled between the host microcontroller 215 and the antenna control circuit 220, is used for receiving the non-audio data from the host controller interface and for controlling the antenna control circuit 220 to use a second pathway of the radio circuit 221 to send the non-audio data. The non-audio data is non-audio data of a human interface device or another data collecting device, and the audio data is an audio stream data for a headset device or another audio device.

The first Bluetooth controller 225A comprises a first baseband control circuit 2251A and a first radio communication circuit 2252A, and the second Bluetooth controller 225B comprises a second baseband control circuit 2251B and a second radio communication circuit 2252B. The first radio communication circuit 2252A, coupled between the radio circuit 221 and the first baseband control circuit 2251A, is dedicated for controlling the antenna control circuit 220 to use the first pathway of the radio circuit 221 to transmit the audio data. The second radio communication circuit 2252B, coupled between the radio circuit 221 and the second baseband control circuit 2251B, is used for controlling the antenna control circuit 220 to use the second pathway of the radio circuit 221 to transmit the non-audio data. The first baseband control circuit 2251A and the second baseband control circuit 2251B are synchronized so as to release time and frequency resources for communications of the first Bluetooth controller 225A and the second Bluetooth controller 225B.

In addition, a host controller interface (HCI) 230 is coupled between the host microcontroller 215 and the first Bluetooth controller 225A and second Bluetooth controller 225B. The host controller interface 230 has a top HCI coupled to the host microcontroller 215 and has a first bottom HCI coupled to the first Bluetooth controller 225A and a second bottom HCI coupled to the second Bluetooth controller 225B. The top HCI can respectively and simultaneously interact with the first bottom HCI and the second bottom HCI so as to transfer different data between the host microcontroller 215 and first Bluetooth controller 225A and transfer different data between the host microcontroller 215 and second Bluetooth controller 225B.

In this embodiment, the host microcontroller 215, first Bluetooth controller 225A, and second Bluetooth controller 225B for example are integrated into a single one IC chip (i.e. the Bluetooth communication device 300). The host controller interface 230 is a layer of Bluetooth control interface and used as a thin layer to transport commands and events between an upper layer stack (i.e. the host microcontroller 215) and a lower layer stack (e.g. the first Bluetooth controller 225A or second Bluetooth controller 225B).

For example (but not limited), for Bluetooth audio transmission, the host microcontroller 215 may output the audio content (i.e. music) into the HCI 230 or receive the audio content (e.g. voice) from the HCI 230. The HCI 230 is used for transporting the audio or voice event (i.e. music or phone call) between the host microcontroller 215 and first Bluetooth controller 225A (which is dedicated to process the higher priority audio through its top HCI and first bottom HCI. The first baseband control circuit 2251A is for example a baseband controller with typical Bluetooth controller function to transmit and receive the audio packet to provide audio purpose communication, such as Bluetooth Classic Audio (i.e. SCO (Synchronous Connection-Oriented) link) or Bluetooth LE (Low Energy) audio link.

In addition, the first baseband control circuit 2251A manages the physical transmission of the Bluetooth RF signal by controlling the first radio communication circuit 2252A to use the first pathway to transfer the audio packets to the headset device 102 or receive the audio packets from the headset device 102.

For Bluetooth non-audio data transmission such as ACL (Asynchronous Connection-Less) link or LE data link, the host microcontroller 215 may output the non-audio data (e.g. Logical Link Control and Adaptation Layer Protocol (L2CAP) data which depends on type of Bluetooth communication) into the HCI 230 or receive the non-audio data from the HCI 230. The HCI 230 is used for transporting the data events and commands (i.e. non-audio data) between the host microcontroller 215 and second Bluetooth controller 225B (which may be used to or dedicated to process the non-audio data) through its top HCI and second bottom HCI. The second baseband control circuit 2251B is for example a baseband controller with a function block to process audio or non-audio packet, an audio codec, and it can disable the function of its audio codec when it is dedicated to create a Bluetooth connection to process the non-audio data. In addition, the second baseband control circuit 2251B manages the physical transmission of the Bluetooth RF signal by controlling the second radio communication circuit 2252B to use the second pathway to transfer the non-audio data to the least one human interface device or receive the non-audio data from the human interface device(s). It should be noted that, since the HCI 230 separately sends the audio content to the first Bluetooth controller 225A and sends the non-audio data to the second Bluetooth controller 225B, it may be not needed to disable the function of the audio codec of the second baseband control circuit 2251B when the second Bluetooth controller 225B is not dedicated to process non-audio data and can be used to process all kinds of Bluetooth signals. The link manager/controller function and the audio codec of the second Bluetooth controller 225B can be respectively enabled and disabled by the host microcontroller 215 to make the second Bluetooth controller 225B be dedicated to process the non-audio data.

In one embodiment, for instance, the host microcontroller 215 is used for sending the audio data and the non-audio data to the host controller interface 230. The top HCI sends the audio data to the first bottom HCI which is coupled to the first Bluetooth controller 225A that is dedicated to process and transfer the audio data, and at the same time the top HCI sends the non-audio data to the second bottom HCI which is coupled to the second Bluetooth controller 225B that is used/dedicated to process and transfer any kinds of data with lower latency requirement. The direction of data reception is reversed and is not detailed for brevity.

In practice, the first Bluetooth controller 225A, coupled between the host microcontroller 215 via the host controller interface 230 and the antenna control circuit 220, is dedicated for receiving the audio data from the host controller interface 230 and for controlling the antenna control circuit 220 to use the first pathway of the radio circuit 221 to send the audio data. For example, the first baseband control circuit 2251A, coupled to the host microcontroller 215 through the host controller interface 230, dedicated for receiving the audio data from the host microcontroller 215, and the first radio communication circuit 2252A, coupled between the antenna control circuit 220 and the first baseband control circuit 2251A, is dedicated for controlling and using the first pathway of the radio circuit 221 to transmit the audio data. The direction of data reception is reversed and is not detailed for brevity.

Alternatively, the second Bluetooth controller 225B, coupled between the host microcontroller 215 and the antenna control circuit 220, is used for receiving the non-audio data from the host controller interface 230 and for controlling the antenna control circuit 220 to use the second pathway of the radio circuit 221 to send the non-audio data. For instance, the second baseband control circuit 2251B, coupled to the host microcontroller 215 through the host controller interface 230, is used for receiving the non-audio data, and the second radio communication circuit 2252B, coupled between the antenna control circuit 220 and the second baseband control circuit 2251B, is used for controlling and using the second pathway of the radio circuit 221 to transmit the non-audio data. The timing of the first baseband control circuit 2251A is synchronized with the timing of the second baseband control circuit 2251B, and thus the first baseband control circuit 2251A and second baseband control circuit 2251B can simultaneously and respectively process the audio data and non-audio data in digital domain. Equivalently, the audio data and non-audio data are simultaneously and respectively sent from the antenna control circuit 220 and radio circuit 221 to the different Bluetooth peripheral devices such as 102, 103, 104, and 105. The direction of data reception is reversed and is not detailed for brevity.

By doing so, in the embodiment, the first Bluetooth controller 225A and second Bluetooth controller 225B can be equivalently integrated as a single one Bluetooth lower layer transmission module, and the protocol behaviors and frequencies/channels of the first Bluetooth controller 225A and second Bluetooth controller 225B in the Bluetooth lower layer transmission module can be respectively controlled by the commands and events generated by the host microcontroller 215 and sent from the HCI 230, so that the frequencies/channels for the audio data and non-audio data can be separated to use the two different radio communication RF channels of the same antenna control circuit 220 and the same radio circuit 221 to send the audio data and non-audio data simultaneously and individually. The advantage is that the two different radio communication pathways can be assembled in the same radio circuit 221 by merely using a combiner circuit, and it is not needed to further use a complicated timing switch circuit to control the antenna control circuit 220. Thus, the circuit costs can be greatly reduced.

Equivalently, the first bluetooth controller 225a and second Bluetooth controller 225B in the lower layer stack are associated with a higher priority and a lower priority respectively in response to different requirements such as a lower latency of audio data) and a reliability (e.g. stable response time) of non-audio data which may not need the latency to be lower. That is, the first Bluetooth controller 225A can be given the higher priority by the host microcontroller 215 to transmit the audio data having the lower latency requirement, and the second Bluetooth controller 225B can be given the lower priority by the host microcontroller 215 to transmit the other data such as non-audio data. Further, since both the first Bluetooth controller 225A and second Bluetooth controller 225B can be controlled by only one host microcontroller 215, this can greatly reduce the circuit size of the Bluetooth communication device 300.

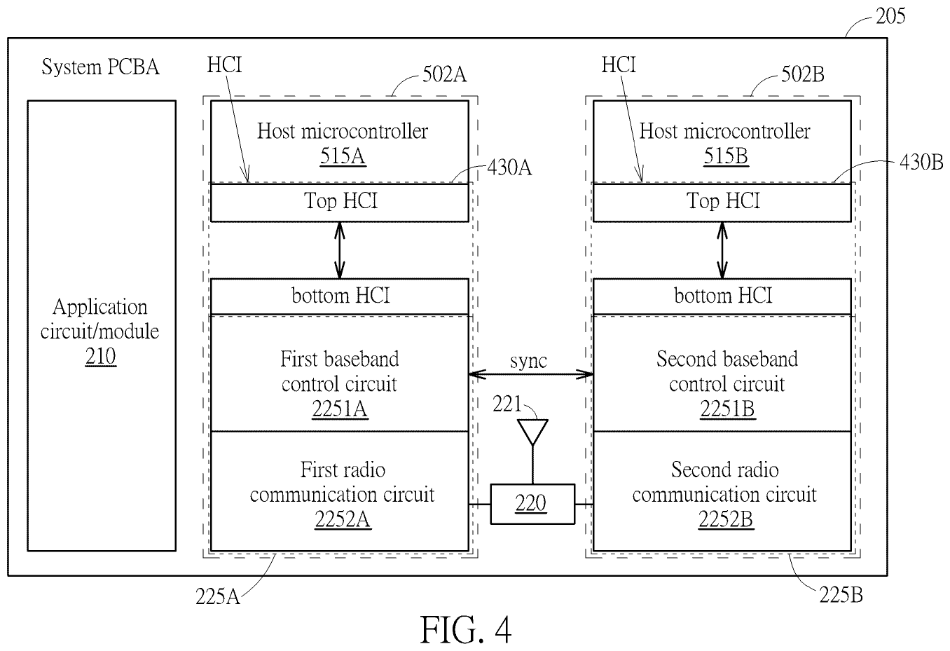

FIG. 4 is a block diagram of the Bluetooth communication devices 502A and 502B according to another embodiment of the invention. As shown in FIG. 4, for example, in practice, the Bluetooth communication devices 502A and 502B are installed on the system PCBA 205 and coupled to the application circuit/module 210 of the host device 101, and the application circuit/module 210 is also installed on the system PCBA 205. Each of the Bluetooth communication devices 502A and 502B may be the device module comprising only one Bluetooth communication circuit and for example the device module is implemented by using a single package based on System in Package (SiP) technology (but not limited).

For example, a first Bluetooth communication device 502A, dedicated for processing and transferring the audio data, comprises a first host microcontroller 515A and a first Bluetooth controller 225A which is coupled to the first host microcontroller 515A through a first HCI 430A having a top HCI and a bottom HCI, and a second Bluetooth communication device 502B, used for processing and transferring the other kinds of data such as the non-audio data different from the audio data, comprises a second host microcontroller 515B and a second Bluetooth controller 225B which is coupled to the second host microcontroller 515B through a second HCI 430B having another top HCI and another bottom HCI. The host microcontroller 515A has the functions and operation similar to those of sub-microcontroller 415A, and the host microcontroller 515B has the functions and operation similar to those of sub-microcontroller 415B; the descriptions are not detailed for brevity.

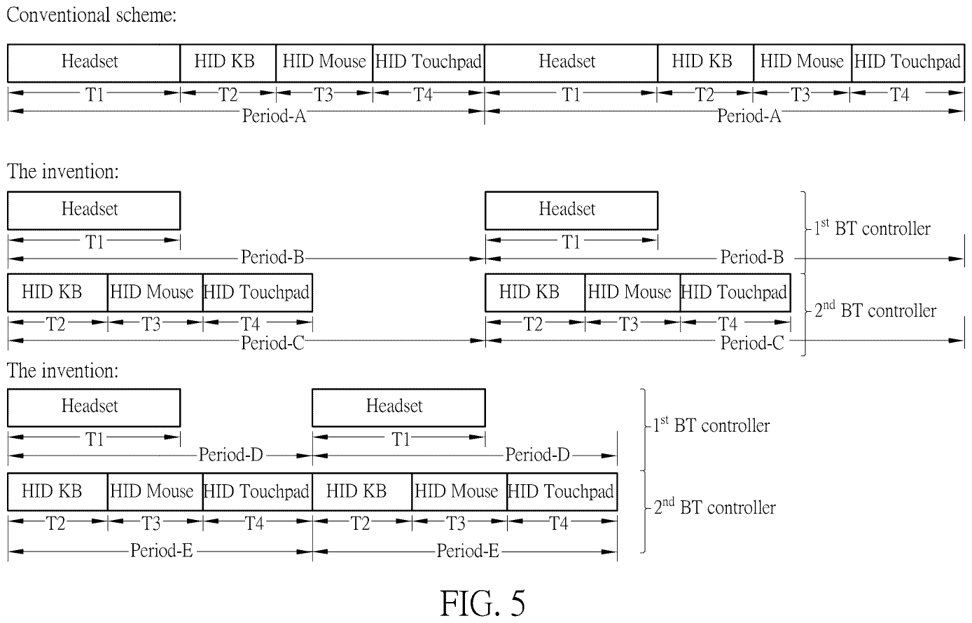

FIG. 5 is a diagram showing the comparison between the conventional scheme's example and the example of the invention of data transmission of different Bluetooth peripheral devices as shown in FIG. 1 according to an embodiment of the invention. As shown in the top portion of FIG. 5, the conventional scheme is to sequentially send different data of the different Bluetooth peripheral devices through the same pathway during a time period such as a time slot (but not limited); for instance, the conventional scheme is to send a first audio data to a headset device during time interval T1 of time period Period-A, then to send a first keyboard data to a keyboard device during time interval T2 of time period Period-A, then to send a first mouse data to a mouse device during time interval T3 of time period Period-A, and then to send a first touch data to a touch pad device during time interval T4 of time period Period-A. Period-A here is a definition of time which the Bluetooth communication device 300 arranges all these Bluetooth connections to different devices with a fixed period to schedule these connections. Then, after the time period Period-A, the same period of “Period-A” will be repeated. The conventional scheme is to send a second audio data to the headset device during time interval T1 of time period Period-A, then to send a second keyboard data to the keyboard device during time interval T2 of time period Period-A, then to send a second mouse data to the mouse device during time interval T3 of time period Period-A, and then to send a second touch data to the touch pad device during time interval T4 of time period Period-A. That is, the conventional scheme is to send different kinds of Bluetooth peripheral data one by one to the corresponding different kinds of conventional peripheral devices. A conventional Bluetooth controller needs to achieve a precise and correct timing control for these Bluetooth arranged in a specific period. This is also a kind of data flow control to make sure several connections stable, but it is not easy to keep several connections always stable in real environment since there are always RF interferences (WiFi signal, other types of 2.4 G RF signals, etc.) exist.

As shown in the middle portion of FIG. 5, in an embodiment of the invention, the Bluetooth communication device 300 simultaneously and respectively send audio data and non-audio data of the different Bluetooth peripheral devices through different connections during a time period such as a time slot (but not limited). For instance, the Bluetooth communication device 300 sends a first audio data to the headset device 102 during time interval T1 of time period Period-B, and at the same time the Bluetooth communication device 300 sequentially sends a first keyboard data to the keyboard device 103 during time interval T2 of time period Period-C, a first mouse data to the mouse device 105 during time interval T3 of time period Period-C, and then a first touch data to the touch pad device 104 during time interval T4 of time period Period-C. The time interval T1 overlaps with the time intervals T2 and T3. This overlapping of time intervals may reduce the timing limitation and simplify the design of precision timing controller when more Bluetooth connections coexist. The advantage is that Bluetooth connection for audio is interference free from non-audio Bluetooth connections by individually control of time slot and radio frequency used. With synchronization timing and frequency occupies between the first and second Bluetooth controller, two Bluetooth pathways could act with individual Bluetooth devices. Similarly, after the time period Period-B, the Bluetooth communication device 300 sends a second audio data to the headset device 102 during time interval T1 of the 2^{nd} time period Period-B, and at the same time the Bluetooth communication device 300 sequentially sends a second keyboard data to the keyboard device 103 during time interval T2 of 2^{nd} time period Period-C, a second mouse data to the mouse device 105 during time interval T3 of 2^{nd} time period Period-C, and then a second touch data to the touch pad device 104 during 2^{nd} time interval T4 of 2^{nd} time period Period-C. As shown in the middle portion of FIG. 5, since the different channels/frequencies are used for audio and non-audio data transferring, the same radio circuit 221 can be shared by the time intervals T1 and T2 of the different Bluetooth connections at the same time or by the time intervals T1 and T3 of the different Bluetooth connections at the same time. In addition, a portion of the time period such as Period-B or Period-C can be an available time resource, e.g. the time between interval T4 of time period Period-B and interval T2 of time period Period-C, and can be occupied and used to transfer different kinds of data between the Bluetooth communication device 300 and any different kinds of Bluetooth peripheral devices. The data transmission of Bluetooth communication can be more efficient.

In another embodiment, the length of one time period can be shorter, i.e. the data transmission of Bluetooth communication can employ a faster transmission rate. Periods for different Bluetooth controller would not be the same due to that the frequency usages of Bluetooth controllers are different. That is, the frequencies used for connection in the first Bluetooth controller 225A are different from frequencies used in the second Bluetooth controller 225B. As shown in the bottom portion of FIG. 5, the Bluetooth communication device 300 sends a first audio data to the headset device 102 during time interval T1 of time period Period-D (which is shorter than time period Period-E), and at the same time the Bluetooth communication device 300 sequentially sends a first keyboard data to the keyboard device 103 during time interval T2 of time period Period-E, a first mouse data to the mouse device 105 during time interval T3 of time period Period-E, and then a first touch data to the touch pad device 104 during time interval T4 of time period Period-E. The time interval T1 overlaps with the time intervals T2 and T3. Similarly, after the time period Period-D or Period-E, the Bluetooth communication device 300 sends a second audio data to the headset device 102 during time interval T1 of 2^{nd} time period Period-D (which is shorter than 2^{nd} time period Period-E), and at the same time the Bluetooth communication device 300 sequentially sends a second keyboard data to the keyboard device 103 during time interval T2 of 2^{nd} time period Period-E, a second mouse data to the mouse device 105 during the time interval T3 of 2^{nd} time period Period-E, and then a second touch data to the touch pad device 104 during the time interval T4 of 2^{nd} time period Period-E. As shown in the bottom portion of FIG. 5, the interval T4 of 1^{st} time period Period-E is configured to be instantly followed by the interval T2 of 2^{nd} time period Period-E, and the Bluetooth communication device 300 can shorten the time period such as Period-D so as to reduce the time length of available time resource if the above-mentioned available time resource is not occupied and used by other Bluetooth devices. The shorter period for Bluetooth connection results in shorter latency performance. In one embodiment, the Bluetooth communication device 300 can dynamically adjust the length of the time period according to the number of Bluetooth peripheral devices which are currently connected to and paired with the Bluetooth communication device 300. By doing so, the data transmission of Bluetooth communication can be more efficient.

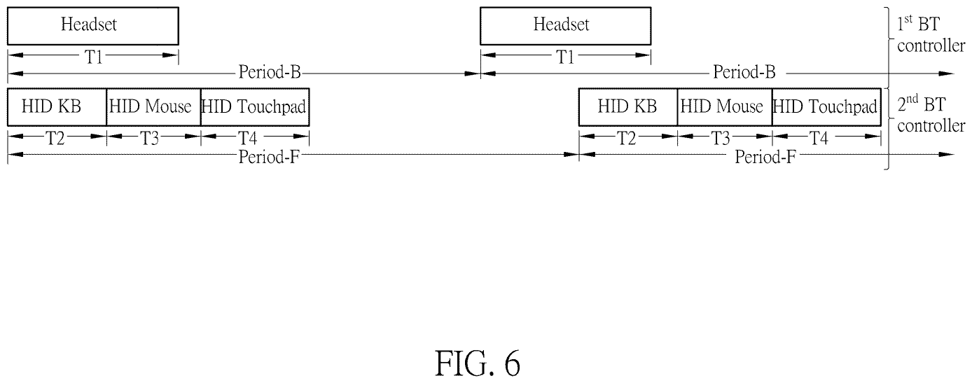

Further, in another embodiment, the time length of the time period of first pathway used by the first Bluetooth controller 225A can be different from that of the time period of second pathway used by the second Bluetooth controller 225B. FIG. 6 is a diagram of the Bluetooth controllers 225A and 225B respectively sending audio data and non-audio data based on different time lengths of the different time periods according to an embodiment of the invention. For example (but not limited), the time period Period-F is configured to be longer than the time period Period-B. The other operations are similar to those mentioned in the example of middle portion of FIG. 5 and are not detailed for brevity.

In another embodiment, the first baseband control circuit 2251A and second baseband control circuit 2251B can be incorporated into a single one baseband controller which respectively and simultaneously sends the audio data into the first radio communication circuit 2252A and sends the non-audio data into the second radio communication circuit 2252B to simultaneously control first radio communication circuit 2252A and second radio communication circuit to transmit the audio data and non-audio data.

Further, the number of second Bluetooth controller 225B is not limited, i.e. a Bluetooth communication device may include multiple second Bluetooth controllers 225B to respectively different kinds of non-audio data into different kinds of human interface devices. This modification also falls within the scope of the invention.

In the embodiments of the invention, the Bluetooth communications/connections are transformed into the scheme of FDMA (Frequency Division Multiple Access) concept, so that the antenna control circuit 220 does not require precise timings to switch the RF signal from the physical antenna (i.e. the radio circuit 221) to a particular radio/controller path. Thus, in the embodiment, it becomes easy to implement the functions and operations of antenna control circuit 220 and radio circuit 221, by using a more basic approach such as a signal combiner or by simply distributing the antenna signals evenly into two or more radio paths. In another example, a more advanced approach may be used to configure high/mid/low band filters into the antenna controller such as the antenna control circuit 221 to respectively operate the current frequency bands used by the controllers for initial band segmentation. This can allow that the two controllers operate more independently without interference. Another implementation may integrate programmable frequency band filters into the antenna control circuit 221 to make frequency segmentation be more flexible through dynamic settings.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A Bluetooth communication device, coupled to a radio circuit and an antenna control circuit, comprising:
a host microcontroller, for sending audio data and non-audio data to a host controller interface;
a first Bluetooth controller, coupled between the host microcontroller and the antenna control circuit, dedicated for receiving the audio data from the host controller interface and for controlling the antenna control circuit to use a first pathway of the radio circuit to send the audio data; and
a second Bluetooth controller, coupled between the host microcontroller and the antenna control circuit, used for receiving the non-audio data from the host controller interface and for controlling the antenna control circuit to use a second pathway of the radio circuit to send the non-audio data.

2. The Bluetooth communication device of claim 1, wherein the non-audio data is non-audio data of a human interface device or another data collecting device, and the audio data is an audio stream data for a headset device or another audio device.

3. The Bluetooth communication device of claim 1, wherein when the first Bluetooth controller sends the audio data through the first pathway, the second Bluetooth controller simultaneously sends the non-audio data through the second pathway.

4. The Bluetooth communication device of claim 1, wherein the first Bluetooth controller sends the audio data during a time period in which the second Bluetooth controller sends the non-audio data simultaneously.

5. The Bluetooth communication device of claim 1, wherein the first Bluetooth controller comprises:
a first baseband control circuit, coupled to the host microcontroller through the host controller interface, dedicated for receiving the audio data; and
a first radio communication circuit, coupled between an radio circuit and the first baseband control circuit, dedicated for controlling the antenna control circuit to use the first pathway of the radio circuit to transmit the audio data; and
the second Bluetooth controller comprises:
a second baseband control circuit, coupled to the host microcontroller through the host controller interface, for receiving the non-audio data; and
a second radio communication circuit, coupled between the radio circuit and the second baseband control circuit, for controlling the antenna control circuit to use the second pathway of the radio circuit to transmit the non-audio data;
wherein a timing of the first baseband control circuit is synchronized with a timing of the second baseband control circuit.

6. The Bluetooth communication device of claim 5, wherein the first baseband control circuit and the second baseband control circuit are incorporated into a single baseband controller which respectively and simultaneously sends the audio data into the first radio communication circuit and sends the non-audio data into the second radio communication circuit; and, the first baseband control circuit and the second baseband control circuit are synchronized so as to release time and frequency resources for communications of the first Bluetooth controller and the second Bluetooth controller.

7. The Bluetooth communication device of claim 1, wherein the host microcontroller comprises a first sub-microcontroller and a second sub-microcontroller, and the first sub-microcontroller and the second sub-microcontroller are integrated in a single system-in-package installed on a same printed circuit board.

8. The Bluetooth communication device of claim 1, wherein the Bluetooth communication device is a single one integrated circuit chip, and the host microcontroller, the first Bluetooth controller, and the second Bluetooth controller are integrated into the single one integrated circuit chip and installed on a same printed circuit board.

9. The Bluetooth communication device of claim 1, wherein a link manager function and an audio codec of the first Bluetooth controller are respectively disabled and enabled by the host microcontroller to make the first Bluetooth controller be dedicated to process the audio data, and a link manager function and an audio codec of the second Bluetooth controller are respectively enabled and disabled by the host microcontroller to make the second Bluetooth controller be dedicated to process the non-audio data.

10. A communication method of a Bluetooth communication device which is coupled to a radio circuit and an antenna control circuit, comprising:
providing a host microcontroller to send audio data and non-audio data to a host controller interface;
using a first Bluetooth controller dedicated to receive the audio data from the host controller interface and to control the antenna control circuit to use a first pathway of the radio circuit to send the audio data; and
using a second Bluetooth controller to receive the non-audio data from the host controller interface and to control the antenna control circuit to use a second pathway of the radio circuit to send the non-audio data.

11. The communication method of claim 10, wherein the non-audio data is non-audio data of a human interface device or another data collecting device, and the audio data is an audio stream data for a headset device or another audio device.

12. The communication method of claim 10, wherein when the audio data is sent by the first Bluetooth controller through the first pathway, the non-audio data is simultaneously sent by the second Bluetooth controller through the second pathway.

13. The communication method of claim 10, wherein the audio data is sent by the first Bluetooth controller during a time period in which the non-audio data is simultaneously sent by the second Bluetooth controller.

14. The communication method of claim 10, further comprising:
using a first baseband control circuit to be dedicated to receive the audio data;
using a first radio communication circuit to be dedicated to control the antenna control circuit to use the first pathway of the radio circuit to transmit the audio data;
using a second baseband control circuit to receive the non-audio data;
using a second radio communication circuit to control the antenna control circuit to use the second pathway of the radio circuit to transmit the non-audio data; and
synchronizing a timing of the first baseband control circuit with a timing of the second baseband control circuit.

15. The communication method of claim 14, further comprising:
incorporating the first baseband control circuit and the second baseband control circuit into a single baseband controller which respectively and simultaneously sends the audio data into the first radio communication circuit and sends the non-audio data into the second radio communication circuit;
wherein the first baseband control circuit and the second baseband control circuit are synchronized so as to release time and frequency resources for communications of the first Bluetooth controller and the second Bluetooth controller.

16. The communication method of claim 10, wherein the host microcontroller comprises a first sub-microcontroller and a second sub-microcontroller, and the communication method further comprises:
integrating the first sub-microcontroller and the second sub-microcontroller in a single system-in-package installed on a same printed circuit board.

17. The communication method of claim 10, wherein the Bluetooth communication device is a single one integrated circuit chip, and the communication method further comprises:
integrating the host microcontroller, the first Bluetooth controller, and the second Bluetooth controller into the single one integrated circuit chip installed on a same printed circuit board.

18. The communication method of claim 10, further comprising:
using the host microcontroller to respectively disable and enable a link manager function and an audio codec of the first Bluetooth controller to make the first Bluetooth controller be dedicated to process the audio data; and
using the host microcontroller to respectively enable and disable a link manager function and an audio codec of the second Bluetooth controller to make the second Bluetooth controller be dedicated to process the non-audio data.
